(19) United States
(12) Patent Application Publication
(10) Pub. No.: US 2013/0173747 A1
(43) Pub. Date: Jul. 4, 2013

(54) SYSTEM, METHOD AND APPARATUS PROVIDING ADDRESS INVISIBILITY TO CONTENT PROVIDER/SUBSCRIBER

(71) Applicants: Young Jin Kim, Basking Ridge, NJ (US); Marina Thottan, Westfield, NJ (US)

(72) Inventors: Young Jin Kim, Basking Ridge, NJ (US); Marina Thottan, Westfield, NJ (US)

(21) Appl. No.: 13/683,195

(22) Filed: Nov. 21, 2012

Related U.S. Application Data
(60) Provisional application No. 61/562,339, filed on Nov. 21, 2011.

(51) Int. Cl. H04L 29/08

(52) U.S. Cl. CPC H04L 67/02
USPC 709/217

(57) ABSTRACT

A method and apparatus for scalably and securely providing address invisibility to a content provider over a network. In various embodiments, the content provider determines the closest geographic rendezvous point node to store content, such that each of the geographic regions may have associated with it one or more nodes, which provide content to a subscriber without directory service to thereby provide address invisibility to the content provider and also the content consumer.

### CROSS REFERENCE TO RELATED APPLICATION

This application claims the benefit of U.S. Provisional Patent Application Ser. No. 61/547,708, filed Oct. 15, 2011, and U.S. Provisional Patent Application Ser. No. 61/562,339, filed Nov. 21, 2011, each of which is hereby incorporated herein by reference in its entirety.

### FIELD OF THE INVENTION

The invention relates generally to the field of communication networks and, more specifically, to self-healing/self-configuration host node arrangement.

### BACKGROUND

The client/server model is the conventional scheme used in content publication over the Internet. This model involves point-to-point communication in a space and time coupling environment. The model is simple but, susceptible to failure and bottleneck, lacks scalability and promotes resource inefficiencies. Although data exchange between applications is done without information associated with the source and destination of the data, communication between the corresponding middleware occurs at the physical layer such that the IP address of each entity is known.

### SUMMARY

Various deficiencies of the prior art are addressed by a method and apparatus for scalably and securely providing address invisibility to a content provider over a network. One embodiment comprises a method for receiving content from a publisher over a network. The method comprises the steps of receiving a request to join a topic group, the request includes characteristics associated with a topic of interest, identifier and geographic location of requester; sending toward the requester a response indicating a result for the request and a topic group identifier; receiving indication of authentication for the requester, the indication being adapted to populate respective topic database; receiving message content for the topic of interest, the message includes the topic group identifier; and caching the message content for the topic of interest using a secure data-centric application extension platform (SeDAX) configured to provide address invisibility to the content provider.

Another embodiment comprises a method for providing content to a subscriber over a network. The method includes the steps of receiving a request to join a topic group including characteristics of a topic of interest, identifier of requester and geographic location determined by a distributed hash function; sending toward the requester a response indicating a result for the request and a group identifier; receiving indication of requester authentication, the indication being adapted to populate respective topic database; providing the content of interest to the subscriber over a secure data-centric application extension platform (SeDAX) adapted to provision the subscriber without directory service to thereby provide address invisibility to the content subscriber.

In various embodiments the steps of receiving indication of requester authentication are performed after the content publisher (subscriber) obtains authentication from a trusted server.

A further embodiment comprises an apparatus for hosting a secure data-centric application extension platform (SeDAX) over a network. The apparatus comprises a processor adapted to perform a plurality of SeDAX functions using a SeDAX middleware suite and a SeDAX host suite; the SeDAX middleware suite enables communications with one or more end users such as publishers or subscribers; the SeDAX host suite enables communications with SeDAX middleware suites and other SeDAX host suites to thereby implement a SeDAX network including one or more trusted servers, wherein a SeDAX host proximate a determined location becomes a Rendezvous place between publishers and subscribers thereby providing address invisibility.

Yet, another embodiment comprises a computer program product for securely requesting content over a network using a secure data-centric application extension platform (SeDAX) adapted to locate contents of publishers without directory service, the computer program product being embodied in a non-transitory computer readable medium storing thereon computer instructions for implementing distributed storage capability over a SeDAX network; providing fine-grained topic or role based access control; and implementing self-healing and self-configuration capability of the SeDAX network; wherein the SeDAX network comprises one or more nodes in communication, each of said one or more nodes having a SeDAX host suite.

### BRIEF DESCRIPTION OF THE DRAWINGS

The teachings of the present invention can be readily understood by considering the following detailed description in conjunction with the accompanying drawings, in which:

FIG. 1A depicts an exemplary Secure Data-centric Application eXtension Platform (SeDAX) communication system including a secure control servers system according to an embodiment;

FIG. 1B depicts an exemplary Secure Data-centric Application eXtension Platform (SeDAX) communication system according to an embodiment;

FIG. 2 depicts a graphical illustration of a pseudo message format according to an embodiment;

FIG. 3 depicts a handshake protocol suitable for use in the SeDAX communication network of FIGS. 1A and 1B;

FIG. 4A depicts an exemplary SeDAX Middleware Suite and SeDAX Host according to an embodiment;

FIG. 4B depicts an exemplary SeDAX Middleware Suite architecture according to one embodiment;

FIG. 5 depicts a Rendezvous based on Geographic Hash Table (GHT) supported by the SeDAX system of FIGS. 1A and 1B;

FIG. 6 depicts a Rendezvous over a Delaunay Triangulated network graph supported by the SeDAX system of FIGS. 1A and 1B;

FIG. 7 depicts one embodiment of a Secure Information Service Bus supported by the SeDAX system of FIGS. 1A and 1B;

FIG. 8 depicts one embodiment of a Cloud-based Demand Response system supported by the SeDAX system of FIGS. 1A and 1 B;

FIG. 9 depicts one Implementation of Decentralized DB over SeDAX supported by the system of FIGS. 1A and 1B; and

FIG. 10 depicts a flow diagram of a method according to an embodiment.

To facilitate understanding, identical reference numerals have been used, where possible, to designate identical elements that are common to the Figures.

### DETAILED DESCRIPTION

The invention will be primarily described within the context of particular embodiments; however, those skilled in the art and informed by the teachings herein will realize that the invention is also applicable to other technical areas and/or embodiments.

Generally speaking, the various embodiments enable, support and/or provide a configuration paradigm enabling one or more content publishers and/or subscribers to send or receive data without directory service to thereby provide address invisibility of the content publishers and/or subscribers.

Some solutions involve programming middleware like JAVA Message Service (JMS) and Data Dissemination Service (DDS) standardized by the Object Management Group. These solutions rely on (1) naming services like Java Naming Directory Service (JNDS); and (2) local caches (within the middleware) placed in either the subscriber or publisher device. Although data exchange between applications is done without information associated with the source and destination of the data, communication between the corresponding middleware occurs at the physical layer, i.e., the IP address of each entity is known. Hence, the importance of publisher/subscriber communication effectively preventing Distributed Denial of Service (DDoS) attacks now takes on a greater degree of priority. Further, publisher/subscriber communication is not resilient to faults as node failures involve disappearing data in local caches wherein all communications can be completely blocked when naming service is attacked.

Various embodiments operate to provide an alternative away from both naming/directory services that are easily exposed to cyber-attacks and local-caching, which is not fault resilient.

The claimed embodiments provide security and reliability. Security is provided in the form of dynamic key distribution, role-base access control through topic-based authentication and strict group communication policy and scalable end-to-end confidentiality compared with IPSec. Dynamic key distribution mitigates the possibility of secret key hack against meters or sensors in one embodiment. Strict group communication policy prevents compromised nodes from developing man-in-the-middle attacks in other embodiments.

In one embodiment, reliability guards against cyber attacks, such that these attacks against the systems are made harder through address invisibility. In another embodiment, self-healing of SeDAX hosts provides resilient service against system failures or cyber-attacks. Yet, in other embodiments reliability is attained through self-configurability in the face of system failures. Further, load balancing through dynamic SeDAX host selection enhances reliability.

The SeDAX platform provides priority routing for applications and reliable multicast compared with Internet Protocol (IP) multicast. SeDAX hosts form a Delaunay Triangulated (DT) network, which provides inter alia (1) small size of neighbor table (e.g., average number of edges is about 6); (2) simple but effective routing; (3) efficient data replication for potential node failure; and (4) quick recovery through local operations, i.e, failure-resiliency.

In a distributed DT network construction embodiment, each node can join the DT network with message exchanges to a number of neighbors. Computation to join the DT network can be done locally. Geographic Hashing Table (GHT) and network caches are used for ensuring Rendezvous between publisher and subscribers. GHT hashes keys into geographic coordinates, and stores a key-value pair at the node geographically nearest the hash of its key. Network caches in the form of content are placed on rendezvous points (RP) determined by GHT. In short, publishers send data to the RP being the closest node to the coordinate generated by a hashing function and then the RP stores the data. Interested subscribers would then query the RP using the same hash function the publishing node utilized. The RP would then send back to the subscriber data matching the characteristics associated with the request. All nodes in the network have to host a middleware corresponding to the node's functionality in the network. For example, a publisher/subscriber would host a SeDAX middleware client.

GHT hash function and greedy forwarding scheme enable locating a node without directory. A node being closest to the location output by hash function dynamically becomes RP.

This arrangement provides security, reliability and scalability as described below.

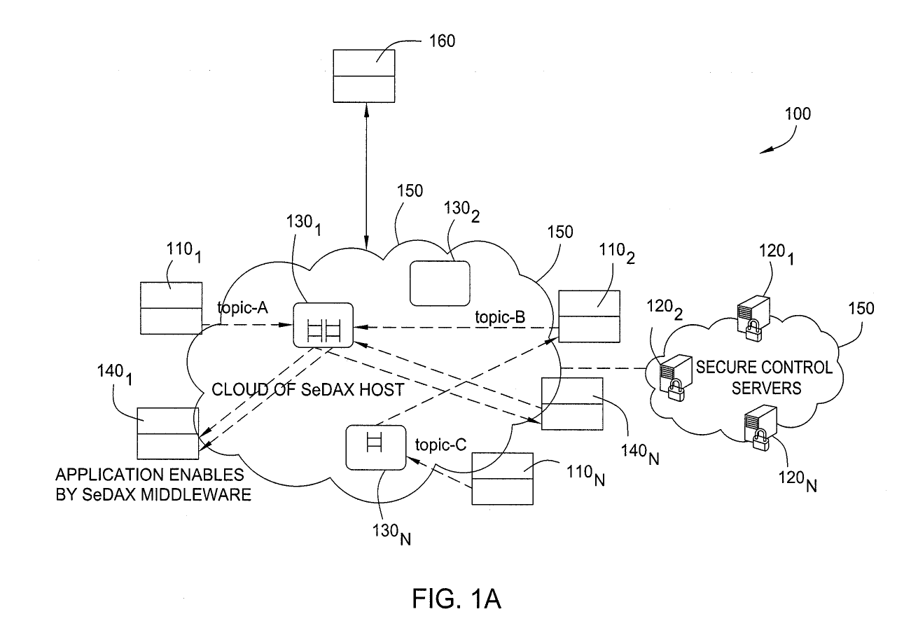

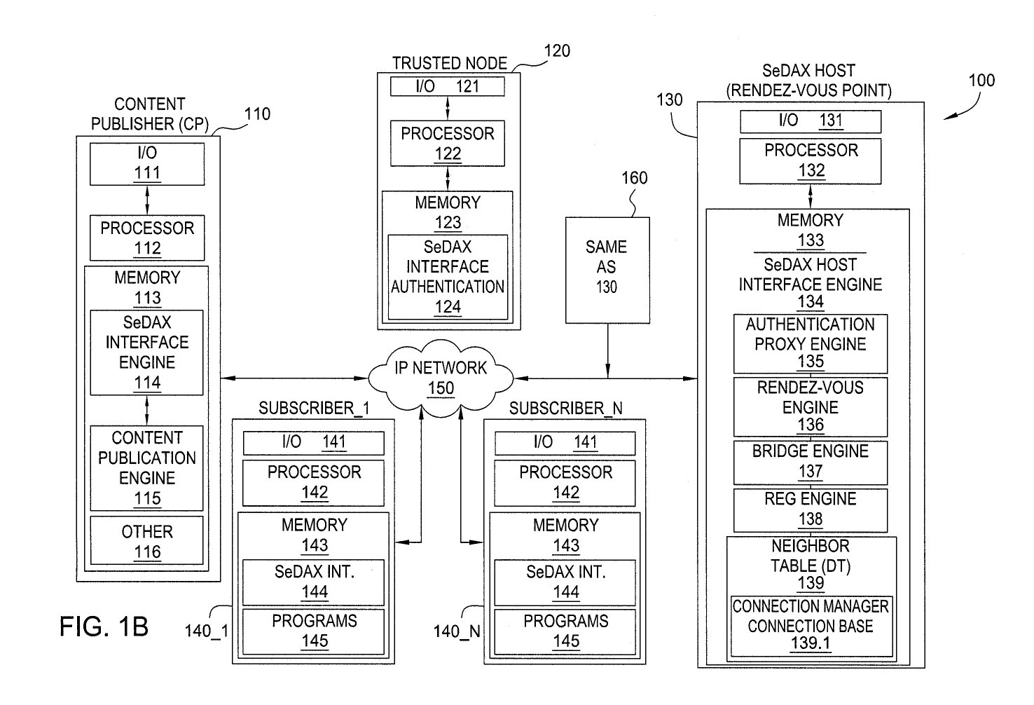

FIG. 1A depicts an exemplary Secure Data-centric Application eXtension Platform (SeDAX) communication system including a secure control servers system according to an embodiment. Specifically, FIG. 1A depicts an exemplary SeDAX communication system 100 that includes a plurality of Content Publishers (CPs) 110, a plurality of trusted nodes or secure control servers 120, a plurality or a cloud of SeDAX hosts (suites) 130, a plurality of subscriber devices (subscribers) 140, IP network 150 and Bridge 160.

SeDAX communication system 100 is an exemplary system only; other types of systems may be used within the context of the various embodiments. The basic configuration and operation of the SeDAX communication system will be understood by one skilled in the art as described herein.

CP 110₁ through CP 110_{N} provide associated content to a proximate SeDAX host on a peer-to-peer basis. Trusted nodes or secure control servers 120₁ through 120_{N} perform authentication for the publishers and subscribers upon request. The result of the authentication process is propagated toward the SeDAX host proximate the requester. In one embodiment, only one trusted node 120 is required. In another embodiment, two or more trusted nodes or a network of trusted nodes may be implemented. Other permutations are also contemplated.

One of a SeDAX host 130₁ through 130_{N} becomes the rendezvous point for a certain topic. Nodes 140₁ through 140_{N} request a topic of interest from SeDAX host 130 on a peer-to-peer basis.

IP Network 150 may be implemented using any suitable communications capabilities. In one embodiment, IP Network 150 is implemented using TCP/IP. In various embodiments, IP Network is implemented using Stream Control Transmission Protocol (SCTP), GPRS Tunnelling Protocol (GTP) and the like.

Bridge 160 is a mirror image of SeDAX host 130. Bridge 160 provides dual redundancy to thereby enable resiliency to faults or cyber-attacks.

These components as well as various components which have been omitted for purposes of clarity, cooperate to provide a Secure Data-centric Application eXtension Platform (SeDAX).

FIG. 1B depicts an exemplary Secure Data-centric Application eXtension Platform (SeDAX) communication system according to an embodiment.

As depicted in FIG. 1B, content publisher (CP) 110 includes I/O circuitry 111, a processor 112, and a memory 113. Processor 112 is adapted to cooperate with memory 113, I/O circuitry 111 to provide various publishing functions for the content publisher.

I/O circuitry 111 is adapted to facilitate communications with peripheral devices both internal and external to processor 112. For example, I/O circuitry 111 is adapted to interface with memory 113. Similarly, I/O circuitry 111 is adapted to facilitate communications with SeDAX interface Engine 114, Content Publication Engine 115 and the like. In various embodiments, a connection is provided between processor ports and any peripheral devices used to communicate with a proximate SeDAX host.

Although primarily depicted and described with respect to SeDAX interface Engine 114 and Content Publication Engine 115, it will be appreciated that I/O circuitry 111 may be adapted to support communications with any other devices suitable for providing the computing services associated with the content publisher (CP).

Memory 113, generally speaking, stores data and software programs that are adapted for use in providing various computing functions within the SEDAX communication system. The memory includes a SeDAX Interface Engine 114 and a Content Publication Engine 115.

In one embodiment, SeDAX Interface Engine 114 and Content Publication Engine 115 are implemented using software instructions which may be executed by processor (e.g., controller 112) for performing the various functionalities depicted and described herein.

Although depicted and described with respect to an embodiment in which each of the engines is stored within memory 113, it will be appreciated by those skilled in the art that the engines may be stored in one or more other storage devices internal to CP 110 and/or external to CP 110. The engines may be distributed across any suitable numbers and/or types of storage devices internal and/or external to CP 110. The memory 113, including each of the engines and tools of memory 113, is described in additional detail herein below.

As described herein, memory 113 includes SeDAX Interface Engine 114 and Content Publication Engine 115, which cooperate to provide the various publishing functions depicted and described herein. Although primarily depicted and described herein with respect to specific functions being performed by and/or using specific ones of the engines of memory 113, it will be appreciated that any of the publishing functions depicted and described herein may be performed by and/or using any one or more of the engines of memory 113. SeDAX Interface Engine 114 comprises the various engines (e.g., encryption/decryption engine, hash function engine, AuthClient engine, NeighborTable, Connection Manager) for use in providing various computing functions including hash functions within the SeDAX communication system.

In one embodiment, publishers 110 send data to a SeDAX host 130 being the closest SeDAX node to the coordinate generated by a hashing function. Hash function and greedy forwarding scheme enable locating a node without directory. Hash function helps with reliability, security and scalability by eliminating the need for naming services. A node being closest to the location output by the hash function dynamically becomes a rendezvous point (RP).

In one embodiment, for a given topic, the appropriate SeDAX host is located using hash function, which makes use of a hash table that factors the network geometry. In one embodiment, the data is forwarded to the closest identified rendezvous (RP) point using the data forwarding scheme called reduced greedy forwarding (RGF) over Delaunay triangulated (DT) graph. DT as the topology of the overlay network provides scalability and resilience. Due to the constrained node degree of a DT graph, RGF over DT (DT-RGF) has a small routing table. Irrespective of the number of nodes in the network, routing table size per node remains constant; the average node degree being less than 6 and the maximum node degree is comparable to the average node degree.

In a distributed DT construction embodiment, a DT is built in a distributed and incremental manner by the flipping algorithm in or using the candidate set approach. Both algorithms are well known in the art and need not be further elaborated upon here. In the case of flipping algorithm, once a joining node is led to a closest node in the existing DT, the triangle enclosing the joining node can be divided and local triangles adjusted by flipping if the new triangle does not meet DT property.

In the candidate-set approach the joining node computes its local DT based on its own candidate set, and updates its candidate set by contacting new neighbors. Distributed DT construction is perfectly scalable to network size. The operations for node join/leave/failure recovery can be done within O(1). For example, if the flipping algorithm for DT construction on 2-dimensional space is used, k/2 operations are needed for a node join in the worst case, and O(k log k) operations are needed for leave/failure recovery, where k is the number of neighbors of the node on DT. The average number of neighbors on DT is bounded to 6, so the complexity of join/leave operation is a constant, whereas most other Distributed Hash Tables (DHT) require O(log N) operations on average where N is the number of nodes in the system.

In one embodiment, Geographic Hashing Table (GHT) is used to determine the closest geographic SeDAX node. GHT hashes keys into geographic coordinates and stores a key-value pair at the node geographically nearest the hash of its key. Generally, GHT uses the perimeter refresh protocol (PRP) to accomplish replication of key-value pairs and their consistent placement at the appropriate home nodes when the network topology changes. GHT routes all packets on a tour of the home perimeter that encloses a destination location. PRP stores a copy of a key-value pair at each node on the home perimeter.

In other embodiment, a suitable algorithm performing the equivalent functions of the GHT may be implemented.

In one embodiment, NeighborTable engine 139 adds a neighbor to the data base. In another embodiment, a neighbor is removed from the data base. In yet another embodiment, the data base is simply updated.

In one embodiment and as further explained later, Authentication Proxy engine 134 communicates with trusted node 120 to authenticate content provider 110.

In one embodiment, connection manager implements the communication protocol to enable communication with trusted node or server 120. In another embodiment, connection manager implements the communication protocol allowing communication with SeDAX host 130.

As depicted in FIG. 1B, trusted node 120 includes I/O Circuitry 121, a processor 122, a memory 123 and SeDAX Interface Authentication 124.

Processor 122 is adapted to cooperate with memory 123, I/O circuitry 121 to provide various authentication functions for the trusted node.

I/O circuitry 121 is adapted to facilitate communications with peripheral devices both internal and external to processor 122. For example, I/O circuitry 121 is adapted to interface with memory 123. Similarly, I/O circuitry 121 is adapted to facilitate communications with SeDAX interface Authentication Engine 124 and the like. In various embodiments, a connection is provided between processor ports and any peripheral devices used to communicate with a proximate SeDAX trusted node.

Although primarily depicted and described with respect to SeDAX Memory 123, it will be appreciated that I/O circuitry 121 may be adapted to support communications with any other devices suitable for providing the computing and/or authentication services associated with the trusted node.

Memory 123, generally speaking, stores data and software programs that are adapted for use in providing various computing and authentication functions within the SeDAX communication system. The memory includes a SeDAX Interface Authentication Engine 124.

In one embodiment, SeDAX Interface Authentication Engine 124 is implemented using software instructions which may be executed by processor (e.g., controller 122) for performing the various functionalities depicted and described herein.

Although depicted and described with respect to an embodiment in which the engines are stored within memory 123, it will be appreciated by those skilled in the art that the engines may be stored in one or more other storage devices internal to trusted node 120 and/or external to trusted node 120. The engines may be distributed across any suitable numbers and/or types of storage devices internal and/or external to trusted node 120. The memory 123, including the engines of memory 123, is described in additional detail herein below.

As described herein, memory 123 includes SeDAX Interface Authentication Engine 124, which cooperates to provide the various authentication functions depicted and described herein. Although primarily depicted and described herein with respect to specific functions being performed by the engines of memory 123, it will be appreciated that any of the authentication functions depicted and described herein may be performed by and/or using the engines of memory 123 or any other suitable configuration performing the equivalent functions.

In various embodiments, SeDAX Interface Authentication Engine 124 comprises a Secure Control Interface providing authentication access control, group communication, data storage, key distribution and the like, as well as various combinations thereof.

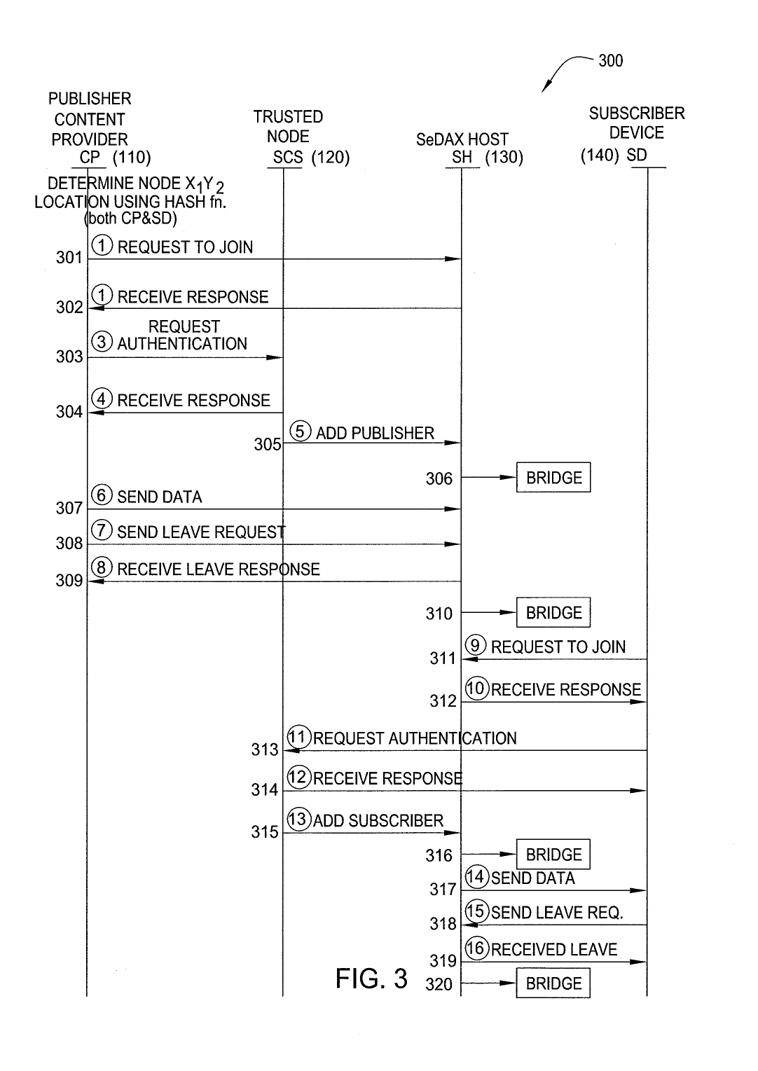

In one embodiment, trusted node or server 120 performs authentication of content publishers 110. In another embodiment, trusted node or server 120 performs authentication of subscribers 140. As depicted in FIG. 3 and described in further details below, trusted node 120 communicates the authentication result to SeDAX host 130.

As depicted in FIG. 1B, SeDAX host 130 includes I/O Circuitry 131, a processor 132, and memory 133.

Processor 132 is adapted to cooperate with memory 133, I/O circuitry 131 to provide various computing and hosting functions for SeDAX host 130.

I/O circuitry 131 is adapted to facilitate communications with peripheral devices both internal and external to processor 132. For example, I/O circuitry 131 is adapted to interface with memory 133. Similarly, I/O circuitry 131 is adapted to facilitate communications with SeDAX host interface Engine 134, Authentication Proxy Engine 135, Bridge Engine 137, rendezvous Engine 136, Reduced Greedy Forwarding (RGF) Engine 138, Authentication Client Engine 139 and the like. In various embodiments, a connection is provided between processor ports and any peripheral devices used to communicate with the SeDAX network.

Although primarily depicted and described with respect to SeDAX host interface Engine 134, Neighbor Table 139, Bridge Engine 136, rendezvous Engine 136, RGF Engine 138, Authentication Client Engine 139, it will be appreciated that I/O circuitry 131 may be adapted to support communications with any other devices suitable for providing the computing and/or authentication services associated with the trusted node.

Memory 133, generally speaking, stores data and software programs that are adapted for use in providing various computing and hosting functions within the SeDAX communication system. The memory includes SeDAX host interface Engine 134, Neighbor Table 139 and Bridge Engine 137, rendezvous Engine 136, RGF Engine 138, Authentication Client Engine 139.

In one embodiment, SeDAX host interface Engine 134, Authentication Proxy Engine 135 and Bridge Engine 137, rendezvous Engine 136, RGF Engine 138, Authentication Client Engine 139 are implemented using software instructions which may be executed by processor (e.g., controller 132) for performing the various functionalities depicted and described herein.

Although depicted and described with respect to an embodiment in which the engines are stored within memory 133, it will be appreciated by those skilled in the art that the engines may be stored in one or more other storage devices internal to SeDAX host 130 and/or external to SeDAX host 130. The engines may be distributed across any suitable numbers and/or types of storage devices internal and/or external to SeDAX host 130. Memory 133, including the engines of memory 133, is described in additional detail herein below.

As described herein, memory 133 includes SeDAX host interface Engine 134, Authentication Proxy Engine 135, Bridge Engine 137, rendezvous Engine 136, RGF Engine 138, Neighbor Table 139, which cooperate to provide the various hosting functions depicted and described herein. Although primarily depicted and described herein with respect to specific functions being performed by the engines of memory 133, it will be appreciated that any of the authentication functions depicted and described herein may be performed by and/or using the engines of memory 133 or any other suitable configuration performing the equivalent functions.

In various embodiments, SeDAX host Interface Engine 133 provides a separate communication path with the different entities. SeDAX Host Interface Engine comprises the various engines for use in providing various computing functions within the SEDAX communication system. In one embodiment, communication with trusted server 120 or servers is established over a secure connection. In another embodiment, communication with trusted server 120 or servers may be implemented using any suitable communications capabilities.

In one embodiment, communication with content publisher 110, subscriber 140 is established over the Internet. In various embodiments, IP Network is implemented using Stream Control Transmission Protocol (SCTP), GPRS Tunneling Protocol (GTP) and the like. In another embodiment, communication with content publisher 110 may be implemented using any suitable communications arrangement.

As depicted in FIG. 3 and described in further details below, authentication proxy engine 134 provides authentication access control, group communication, data storage, key distribution and the like, as well as various combinations thereof.

As previously stated, one of a SeDAX host 130₁ through 130_{N} becomes the rendezvous point (RP) for a certain topic. Publishers send data to the RP being the closest node to the coordinate generated by a hashing function and then the RP stores the data. Interested subscribers would then query the RP using the same hash function the publishing node utilized. The RP would then send back to the subscriber data matching the characteristics associated with the request. The hash function helps reliability, security and scalability by eliminating the need for naming services.

In one embodiment, rendezvous engine 136 interfaces with each and every functional block within SeDAX hosts interface engine 134 performing the various hosting functions depicted and described herein.

In another embodiment, rendezvous engine 136 interfaces with SeDAX hosts interface engine 134 in any suitable manner to implement the various hosting functions depicted and described herein. SeDAX implementation comprises a plurality of topic-based interfaces. In one embodiment, a streaming topic-based embodiment is implemented. In another embodiment, a query/reply topic-based embodiment is implemented.

In other embodiments, automated demand response with utility price, reliability or event signals trigger customers' pre-programmed energy management strategies. In other embodiments, a decentralized data base (DB) over SeDAX is implemented.

Several SeDAX communication functions are implemented in a SeDAX host. In one embodiment, rendezvous engine 136 interfaces primarily with Reduced Greedy Forwarding (RGF) Engine 138 to implement dynamic host selection for a topic group. In another embodiment, rendezvous engine 136 implements an interface for topic-based authentication and key distribution. In another embodiment, rendezvous engine 136 provides for secure and reliable data multicast for a topic group. Strict group communication policy prevents compromised nodes from developing man-in-the-middle attacks in other embodiments.

In one embodiment, rendezvous engine 136 provides for dynamic host selection for a topic group. In another embodiment, rendezvous engine 136 provides for interface for topic-based authentication and key distribution.

In another embodiment, rendezvous engine 136 provides for secure and reliable data multicast for a topic group.

In one embodiment, rendezvous engine 136 provides for data replication. In other embodiment, rendezvous engine 136 provides for load balance.

FIG. 1B depicts an exemplary Secure Data-centric Application eXtension Platform (SeDAX) communication system according to an embodiment.

As depicted in FIG. 1 B, subscriber device (SD) 140 includes I/O circuitry 141, a processor 142, and a memory 143. Processor 142 is adapted to cooperate with memory 143, I/O circuitry 141 to provide various functions for the subscriber.

I/O circuitry 141 is adapted to facilitate communications with peripheral devices both internal and external to processor 142. For example, I/O circuitry 141 is adapted to interface with memory 143. Similarly, I/O circuitry 141 is adapted to facilitate communications with SeDAX interface Engine 144, Programs 145 and the like. In various embodiments, a connection is provided between processor ports and any peripheral devices used to communicate with a proximate SeDAX host.

Although primarily depicted and described with respect to SeDAX interface Engine 144 and Programs 145, it will be appreciated that I/O circuitry 141 may be adapted to support communications with any other devices suitable for providing the computing services associated with the content publisher (CP).

Memory 143, generally speaking, stores data and software programs that are adapted for use in providing various computing functions within the SeDAX communication system. The memory includes a SeDAX Interface Engine 144 and Programs 145.

In one embodiment, SeDAX Interface Engine 144 and Programs 145 are implemented using software instructions which may be executed by processor (e.g., controller 142) for performing the various functionalities depicted and described herein.

Although depicted and described with respect to an embodiment in which each of the engines is stored within memory 143, it will be appreciated by those skilled in the art that the engines may be stored in one or more other storage devices internal to SD 140 and/or external to SD 140. The engines may be distributed across any suitable numbers and/or types of storage devices internal and/or external to SD 140. Memory 143, including each of the engines and tools of memory 143, is described in additional detail herein below.

As described herein, memory 143 includes SeDAX Interface Engine 144 and Programs 145, which cooperate to provide the various functions depicted and described herein. Although primarily depicted and described herein with respect to specific functions being performed by and/or using specific ones of the engines of memory 143, it will be appreciated that any of the functions depicted and described herein may be performed by and/or using any one or more of the engines of memory 143. SeDAX Interface Engine 144 comprises the various engines (e.g., encryption/decryption engine, hash function engine, AuthClient engine, NeighborTable, Connection Manager) for use in providing various computing functions including hash functions within the SeDAX communication system.

In one embodiment, subscribers 140 receive data from a SeDAX host 130 being the closest SeDAX node to the coordinate generated by a hashing function. Hash function and greedy forwarding scheme enable locating a

SeDAX host node without directory. Hash function helps with reliability, security and scalability by eliminating the need for naming services. A node being closest to the location output by the hash function dynamically becomes a rendezvous point (RP).

In one embodiment, for a given topic, the appropriate SeDAX host is located using hash function, which makes use of a hash table that factors the network geometry. In one embodiment, the data is sent by the closest identified rendezvous point (RP) using the data forwarding scheme called Reduced Greedy Forwarding (RGF) over Delaunay triangulated (DT) graph. DT as the topology of the overlay network provides scalability and resilience. Due to the constrained node degree of a DT graph, RGF over DT (DT-RGF) has a small routing table. Irrespective of the number of nodes in the network, routing table size per node remains constant; the average node degree being less than 6 and the maximum node degree is comparable to the average node degree.

In one embodiment, Geographic Hashing Table (GHT) is used to determine the closest geographic SeDAX node. GHT hashes keys into geographic coordinates and stores a key-value pair at the node geographically nearest the hash of its key. In another embodiment, a suitable algorithm performing the equivalent functions of the GHT may be implemented.

In one embodiment, NeighborTable engine 139 adds a neighbor to the data base. In another embodiment, a neighbor is removed from the data base. In yet another embodiment, the data base is simply updated.

In one embodiment and as further explained later, Authentication Proxy Engine communicates with trusted node 120 to authenticate subscriber 140.

In one embodiment, connection manager implements the communication protocol to enable communication with trusted node or server 120. In another embodiment, Connection Manager 139.1 implements the communication protocol to enable communication with SeDAX host 130.

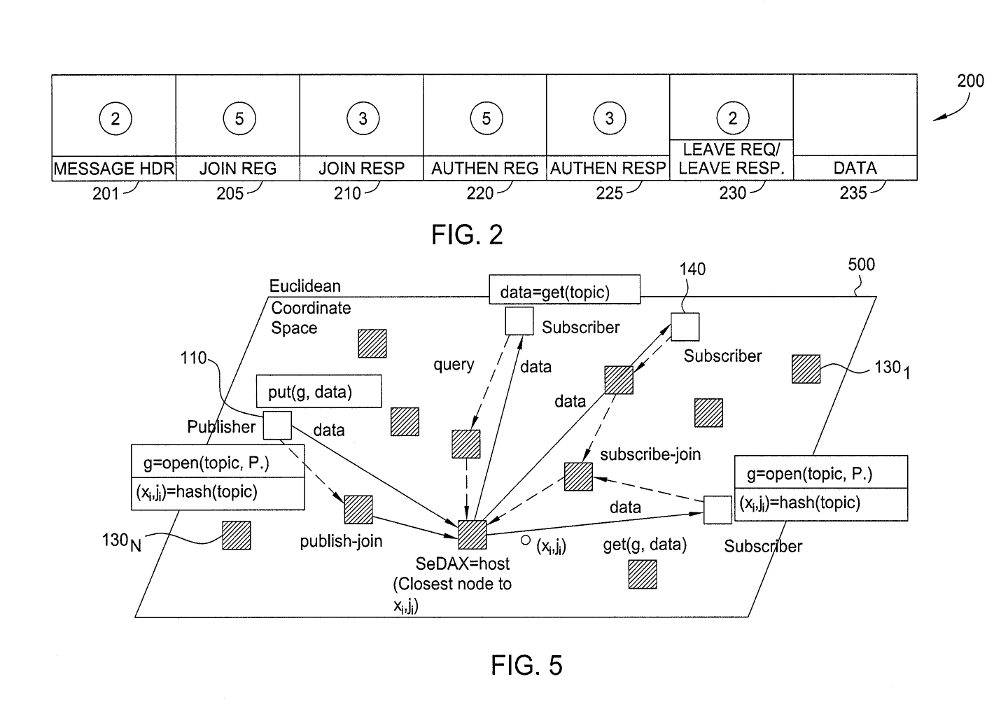

FIG. 2 depicts a graphical illustration of a pseudo message format according to an embodiment. In various embodiments, the pseudo message format provides a plurality of alternatives. In one embodiment, the pseudo message comprises seven (7) fields with each field having one or more respective subfields. Field 301, “MessageHdr” comprises two subfields; namely, (1) “messagetype” and (2) “messagelen.” Message type indicates a signaling message when the data is “11111111 XXXXXXXX.” Otherwise, the message type subfield indicates a data message with a group ID included. A group ID indicates a certain topic-group assigned within a rendezvous point. Messagelen which is the second subfield of MessageHdr field indicates the length of the message. Field 205 “JoinReq” is propagated by a node toward the nearest located RP indicating a request to join. JoinReq comprises five (5) subfields; namely, (1) “dest_coord,” which is a geographic location determined by a hash function; (2) “srcaddr,” which is the IP address of the source node; (3) “scrport,” which is a 16-bit word indicating the source port; (4) “pubsubid,” which is the identifier of a publisher or subscriber to receive response messages from a SeDAX host; and (5) “topic[ ],” which indicates the topic of interest. Field 210 “JoinResp” provides a response to the request to join. “JoinResp” comprises three (3) subfields; namely, (1) “pubsubid” described above; (2) “result,” which provides the result of establishing the communication link; and (3) “groupid,” which is described above. Field 220 “AuthenReq,” requests authentication from trusted node 120 using the publisher or subscriber identifier. “AuthenReq” comprises five (5) subfields; namely, (1) “pubsubid” which is the identifier of a publisher or subscriber to receive response messages from a SeDAX host; (2) “groupid,” which indicates a certain topic-group assigned within a rendezvous point; (3) “randa,” which is a random number obtained from a Diffie-Hellman key exchange; (4) “randb,” which is a random number obtained from a Diffie-Hellman key exchange; and (5) “topic[],” which indicates the topic of interest. Field 225 “AuthenResp,” provides a response in reply to the request. “AuthenResp” comprises three (3) subfields; namely, (1) “pubsubid” which is the identifier of a publisher or subscriber to receive response messages from a SeDAX host; (2) “result,” which provides the result of establishing the communication link; and (3) “credential,” which is an input to Diffie-Hellman-key exchange generating a symmetric key for confidentiality and it is encrypted by the symmetric key. Field 230 “LeaveReq/LeaveResp,” which is propagated towards a SeDAX host in reply to the request. A SeDAX host would propagate a response to the particular subscriber requesting the leave. “LeaveReq/LeaveResp” comprises two (2) subfields; namely, (1) “pubsubid” which is the identifier of a publisher or subscriber to receive response messages from a SeDAX host; and (2) “groupid,” which indicates a certain topic-group assigned within a rendezvous. Field 235 “Data” contains the payload.

FIG. 3 depicts a handshake protocol suitable for use in the SeDAX communication network of FIGS. 1A and 1B.

Geographic Hashing Table (GHT) and network caches are used for ensuring rendezvous between publisher and subscribers. GHT hashes keys into geographic coordinates, and stores a key-value pair at the SeDAX node geographically nearest the hash of its key. Network caches in the form of content are placed on rendezvous points (RP) determined by GHT. In short, publishers send data to the RP being the closest node to the coordinate generated by a hashing function and then the RP stores the data. Interested subscribers would then query the RP using the same hash function the publishing node utilized. The RP would then send back to the subscriber data matching the characteristics associated with the request.

Authentication is required for both content providers and subscribers as the first step in the process. Trusted nodes or secure control servers 120₁ through 120_{N} perform authentication for the publishers and subscribers upon request. The result of the authentication process is propagated toward the SeDAX host proximate the requester.

In one embodiment, having located the nearest RP using a hash function as described above, in step 301 CP 110 propagates a request to join toward the nearest located RP. The message format is depicted in FIG. 3. In reply to the join request, in step 302 the RP provides a response comprising the identifier of the publisher or subscriber to receive response messages from a SeDAX host and a certain topic-group assigned within an RP. Using the publisher or subscriber identifier, in step 303 CP 110 requests authentication from trusted node 120. In reply to the request, in step 304 trusted node 120 provides a response to CP 110 comprising the result and a credential. In one embodiment, the credential is an input to Diffie-Hellman-key exchange generating a symmetric key for confidentiality and it is encrypted by the symmetric key. In step 305, trusted node 120 propagates a message to SeDAX host 130 to add CP 110. In step 306, SeDAX host 130 propagates a message toward Bridge 160 to also add CP 110. This arrangement provides a back-up or redundancy to RP.

In one embodiment, with respect to data dissemination when a RP node collapses, the second closest node to the RP autonomously becomes RP node for the topics. In another embodiment, with respect to data storage, Bridge 160 is a replica of the nearest RP to Bridge 160.

In step 307, CP 110 may initiate data transfer to SeDAX host 130. At the end of the transfer process, the channel is closed.

In one embodiment, to be removed from a certain group CP 110 would propagate a leave request to SeDAX host 130 in step 308. In reply to the request, in step 309 SeDAX host 130 propagates a response to the particular content publisher requesting the leave. At step 310, SeDAX host 130 would inform Bridge 160 to remove the particular content provider/publisher.

In one embodiment, having located the nearest RP using a hash function as described above, in step 311 SD 140 propagates a request to join to the nearest located RP. The message format is depicted in FIG. 5. In reply to the join request, in step 312 the RP provides a response comprising the identifier of the subscriber to receive response messages from a SeDAX host and a certain topic-group assigned within an RP. Using the subscriber identifier, in step 313 SD 140 requests authentication from trusted node 120. In reply to the request, in step 314 trusted node 120 provides a response to SD 140 comprising the result and a credential. In one embodiment, the credential is an input to Diffie-Hellman-key exchange generating a symmetric key for confidentiality and it is encrypted by the symmetric key. In step 315, trusted node 120 propagates a message to SeDAX host 130 to add SD 140. In step 316, SeDAX host 130 propagates a message toward Bridge 160 to also add SD 140. This arrangement provides a back-up or redundancy to RP.

In step 317, SeDAX host 130 may initiate data transfer to SD 140. At the end of the transfer process, the channel is closed.

In one embodiment, to be removed from a certain group SD 140 would propagate a leave request to SeDAX host 130 in step 318. In reply to the request, in step 319 SeDAX host 130 propagates a response to the particular subscriber requesting the leave. At step 320, SeDAX host 130 transmits a message to Bridge 160 to remove the particular subscriber.

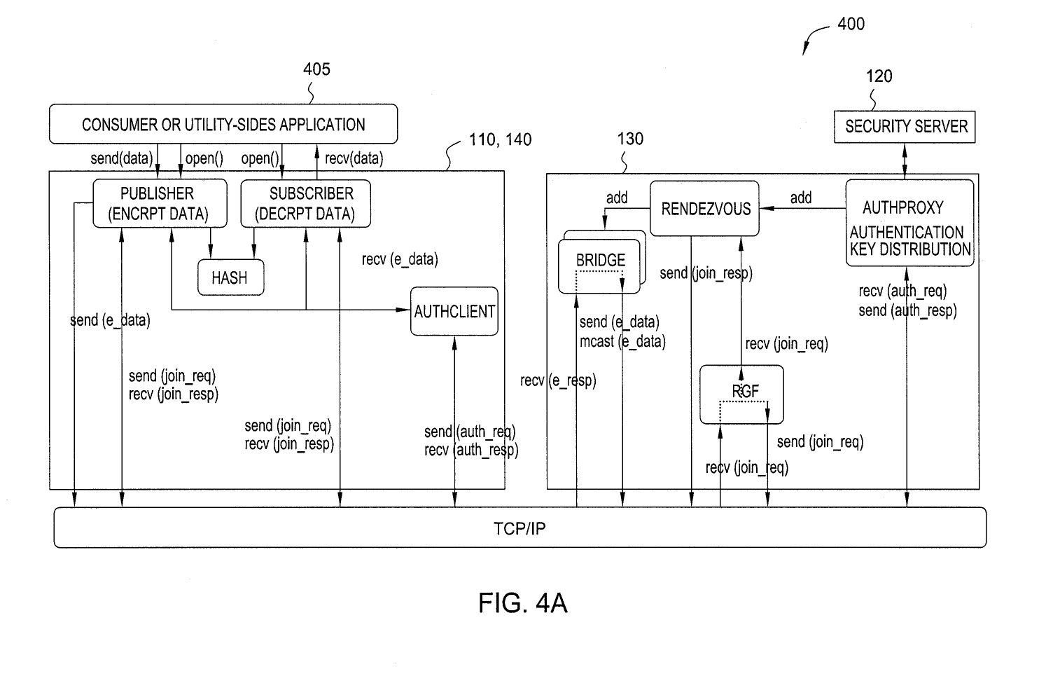

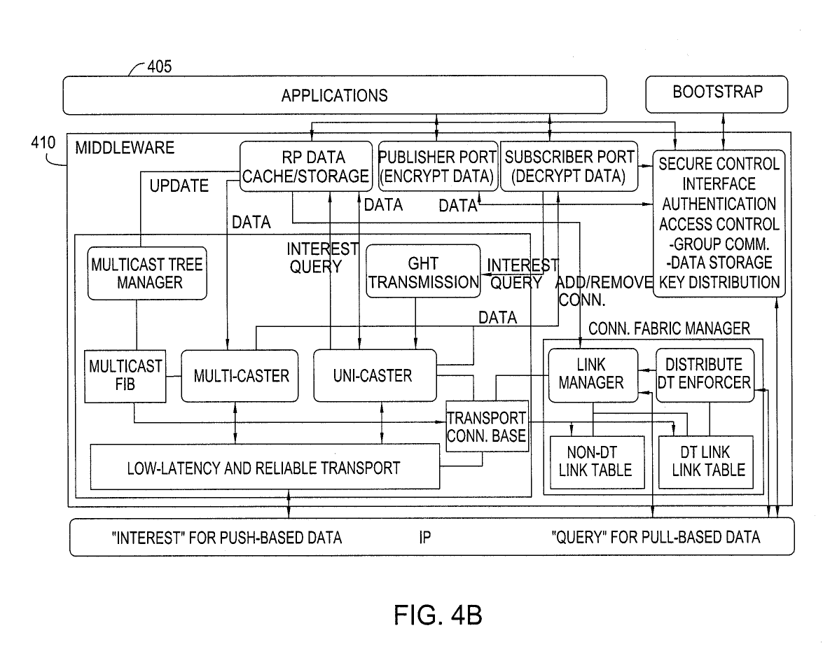

FIG. 4A depicts an exemplary SeDAX Middleware Suite and SeDAX Host according to an embodiment. The SeDAX network is an overlay network which consists of a Delaunay Triangulated (DT) graph having SeDAX nodes 130 as vertices and transport layer connections between any two neighboring nodes as edges. SeDAX middleware 410 discussed with respect to FIG. 4B is a software library that provides applications with interfaces to the SeDAX network. In various embodiments, SeDAX middleware 410 can be executed on hardware platforms having a broad range of computation capability.

A SeDAX node 130 is a computing entity that enables topic-group communications. In one embodiment, SeDAX node 130 requires preferably a computation capability in the order of 500 MHz of computing power. In other embodiments, SeDAX node 130 requires a computation capability less than the 500 MHz of computing power.

In various embodiments, a network of security servers 120 is deployed within the security perimeters of the location, and is responsible for the secure control of SeDAX platform elements.

SeDAX implementation comprises a plurality of topic-based interfaces. In one embodiment, a streaming topic-based embodiment is implemented. In another embodiment, a query/reply topic-based embodiment is implemented.

In other embodiments, applications 405 comprise automated demand response with utility price, reliability or event signals, which trigger customers' pre-programmed energy management strategies. In other embodiments, applications 405 comprise a decentralized data base (DB) over SeDAX.

Central to SeDAX is topic-group communications, where each topic is defined by fields such as data type, location, and time.

In one embodiment, for a given topic, a uniform hash function shared by SeDAX middleware instances 400 produces a location in a given planar coordinate space. Given a topic's search key, a hash function is used for quickly locating a data record from a large data set. More specifically, in SeDAX the hash function maps the topic to the hash (index) which in turn gives the location of the corresponding data for either retrieval or storage purposes. For a given topic-group (e.g., AMI data at 12:00:00 EST on Mar. 1, 2012, New York area), all messages associated with the particular topic-group are sent to a respective destination location in a given geographic coordinate system. Any instance of a SeDAX middleware has to be authenticated for accessing a particular topic-group. Therefore, the joining entity sends a group-join message (destined to the respective location) to a SeDAX node associated with it (at system initialization time) and this message is forwarded over a (Delaunay Triangulation) DT-based SeDAX network using a multi-hop forwarding algorithm such as DT-GHF. When the message reaches the SeDAX node closest to the location of the node requesting the particular topic, a secure control server establishes a secure session with the message source so that the massage source can exchange authentication messages with the security server connected to the closest SeDAX node. A SeDAX node 130 is agnostic to the authentication messages as message source's credentials are known only by security servers 120. This hash function based approach to access data enables fine grained access control and replaces traditional naming services that have resilience concerns.

In various embodiments, SeDAX operations fall under one of the following four (4) categories, namely, (1) Node Bootstrap, Coordinates, and Discovery; (2) Topic-group, Hashing and Multi-hop Forwarding; (3) Distributed DT Construction; and (4) Authentication and Confidentiality.

In the Node Bootstrap embodiment, whenever a new SeDAX node 130 is booted up, the node has to be authenticated by a security server via the bootstrap server. The bootstrapping task is considered a special topic-group and can be handled by a specific authentication process described below. Newly authenticated SeDAX nodes can establish edges (TCP connections) to their neighboring SeDAX nodes using a DT construction process. Each node needs its own coordinates for SeDAX operations. A network coordinate system is required to embed network latency information. Thus, whenever a SeDAX node joins a SeDAX network, its coordinates are assigned by a security server. This assignment is made based on the measurement of latency to existing nodes in the coordinate system. This measurement task is not cumbersome in low-churn Smart Grid communication networks where node join/leave events occur infrequently. During system loading time, a SeDAX middleware must discover SeDAX nodes either on the subnet where it is situated or on other subnets. After the discovery process is completed, the SeDAX middleware maintains association with these SeDAX nodes. For scalability, SeDAX nodes themselves do not keep the state of the SeDAX middleware. If there are existing SeDAX nodes in the network, they can function as bootstrap servers for new SeDAX nodes such that all SeDAX nodes have its own public-private key pairs and are associated with a list of bootstrap servers for new SeDAX nodes.

In the Topic-group embodiment, a topic is defined by data type, location, and time. When a topic specified by an application is passed to either a publisher object or a subscriber object, the topic is input to a geographic hash function which outputs coordinates for the location on a given Euclidean space. A group-join message destined to the determined location is then sent to a SeDAX node associated with the determined location at system initialization time. The SeDAX node forwards the message over a DT-based SeDAX network using the multi-hop forwarding algorithm, DT-GHF. When the message reaches the SeDAX node currently closest to determined location, a topic-group manager in the SeDAX node receives the message and then establishes a secure session with the message source's security client. The security client exchanges authentication messages with a security server using the authentication protocol shown in FIG. 3. The communications with the security server occurs over a secure session. After the topic-group manager in the SeDAX node is notified of successful authentication from the security server, the secure session to the security client is terminated and the topic-group manager reserves memory resources for either streaming-based or query-based data dissemination/storage. The security server is the entity that determines whether a streaming service or a storage/query service is appropriate for a given topic-group. In one embodiment, the above process is initiated by a Smart Grid application on a per topic of interest.

In the Distributed DT Construction embodiment, a DT graph can be built in a variety of ways. In one embodiment, a DT graph can be built in a distributed and incremental manner by the well-known flipping algorithm. In another embodiment, a DT graph is built using the well-known candidate-set algorithm.

In the flipping algorithm, once a joining node is led to a closest node in an existing Delaunay triangle, the triangle enclosing the joining node is divided into new triangles. The new triangles are adjusted by flipping edges if the triangles do not meet the DT property, e.g., for two triangles ΔABD and ΔCBD with common edge BD, if the sum of two angles <BAD and <BCD is more than 180° (namely, the triangles do not meet the Delaunay property), switching common edge BD for common edge AC produces two new triangles ΔABC and ΔADC that meet the Delaunay property.

In the candidate-set algorithm, the joining node computes its local DT graph based on the joining node's own candidate set. The joining node updates its candidate set by contacting any new neighbors. One of the advantages of the distributed DT construction is that it is perfectly scalable to network size. The operations for node join/leave/failure recovery can be done within O(1) operations. For example, if the flipping algorithm is used for DT construction on a 2-dimensional space, only k/2 operations are needed for node join in the worst case, and 0(k log k) operations are needed for node-leaving/failure-recovery, where k is the number of neighbors of the node on DT.

In the Authentication and Confidentiality embodiment, the cluster of security servers constituting a trusted network provides authentications for both new SeDAX host nodes joining a DT network of SeDAX nodes and the middleware of new security clients accessing a topic-group. SeDAX node authentication is based on public key certificates (X.509 and certificate authority) and is necessary for preventing man-in-the-middle attacks. In one embodiment, a SeDAX node has its own public-private key pairs as well as a preconfigured public key certificate of the trusted network. In another embodiment, a different arrangement is contemplated where the public key certificate of the trusted network is not preconfigured.

A SeDAX node which is about to join a Delaunay Triangulation (DT) network has to be authenticated by one of the security servers protecting the DT network. In one embodiment, mutual-authentication messages are exchanged between the SeDAX node and an arbitrary security server. The procedure for authentication is similar to the well known client authenticated Transport Layer Security (TLS) handshake. Having been authenticated, the SeDAX node obtains a public key certificate from the security server. As the newly authenticated node establishes an edge with an existing node in the DT network, the two nodes authenticate each other. This mutual authentication is executed through an exchange of the nodes' public key certificates. Using the trusted network's public key certificate, the nodes can verify each other's public key certificate.

Another embodiment supports security clients running over low-power hardware platforms. This embodiment comprises a topic-group authentication. In this embodiment, authentication messages between a security client of the SeDAX middleware and an arbitrary security server are encrypted using a symmetric key rather than a public key. Symmetric key based authentication is similar to the well known scalable and secure transport protocol (SSTP11) for smart grid data collection and need not be further discussed here.

In one embodiment, after a security client is authenticated, a security server determines the client's access permission to a topic data by checking the client's preprovisioned privileges. For example, no sensor/meter is allowed to participate in a “data-collection” group as a subscriber member.

In another embodiment, a security server manages one group master key and one session key generator derived from the master key for a given topic-group g. The session key generator is assigned to all subscriber clients associated with the topic-group g. As for each publisher client associated with the topic-group g, one session key created by the session key generator is assigned to the publisher client. Note that each group master key is created not on a per client basis but on a per topic-group. This allows scalable access control over the topics where the number of topics is less than the number of clients. Data encrypted by the publishers with a session key according to the advanced encryption standard (AES) can be decrypted only by subscribers that can extract the session key (E2E confidentiality). The foregoing approach can preserve the confidentiality of the communications of other publishers even when a publisher's session key is exposed. Moreover, a session key update is not required each time a new member joins the group.

FIG. 4B depicts an exemplary SeDAX Middleware Suite architecture according to one embodiment. Specifically, the SeDAX middleware supports the following three communication primitives for applications 405, namely, (1) open {topic, role}; (2) write {data}; and (3) read {data}. For a topic-group g, when an application 405 calls either open(g, PUBLISHER) or open(g, SUBSCRIBER), either a publisher object or a subscriber object is created within SeDAX middleware 410. If either object successfully joins a topic-group in a SeDAX network, it returns a pointer to the object to the calling application 405. Otherwise, it returns a NULL.

Using write( ) an application 405 can pass its own data to a publisher object in the SeDAX middleware which will then encrypt the data and pushes the encrypted data to the SeDAX network. However, if the write( ) primitive is called on a subscriber object or on a nonexistent object, it is immediately returned with an error.

Using read( ) operation, an application 405 can read data from a subscriber object in the SeDAX middleware which then receives data from the SeDAX network. For streaming data access, whenever data from a SeDAX network arrives at the subscriber object, the object calls the read( ) primitive to notify its associated application of the arrival of new data. For query-based data retrieval, an application calls the read( ) primitive to request the subscriber object to pull data from a SeDAX network. Then, it waits for a while until the subscriber object obtains the requested data.

In other embodiments, additional primitives are supported. FIG. 5 depicts a rendezvous based on Geographic Hash Table (GHT) supported by the SeDAX system of FIGS. 1A and 1B.

GHT hash function and greedy forwarding scheme enables locating a node without directory. A node being closest to the location output by hash function dynamically becomes RP. This arrangement provides security, reliability and scalability as described below.

In one embodiment, Geographic Hashing Table (GHT) is used to determine the closest geographic SeDAX node. GHT hashes keys into geographic coordinates and stores a key-value pair at the node geographically nearest the hash of its key. In other embodiment, a suitable algorithm performing the equivalent functions of the GHT may be implemented.

In one embodiment, data storage is performed on a query/response basis and transmitted via unicast based on GHT result. The handshake protocol is depicted in FIG. 3. In another embodiment, data retrieval is performed on a query/response basis and transmitted via unicast based on GHT result. In data dissemination embodiment, interests are transmitted via unicast based on GHT and data is transmitted via multicast on revere-path three.

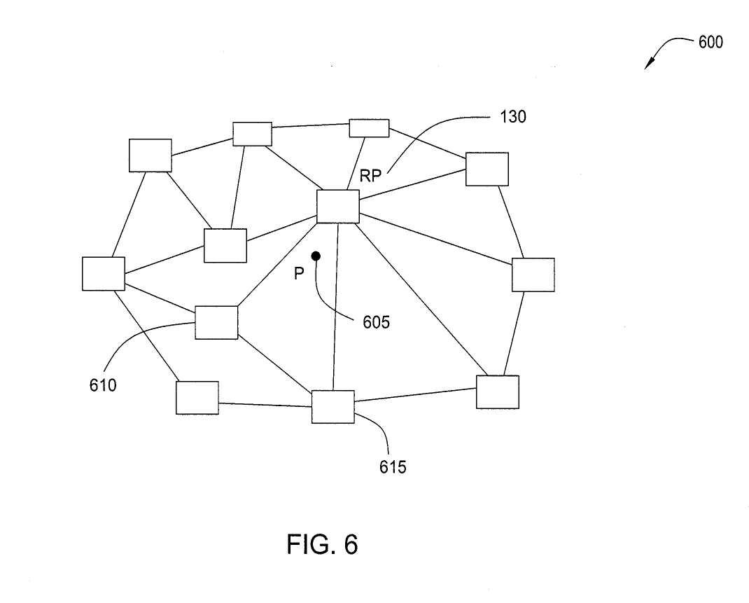

FIG. 6 depicts one embodiment of a self-healing/self-configuration system supported by the SeDAX system of FIGS. 1A and 1B.

The infrastructure is architected to provide a platform capable of self-configurability in the face of system failures. In one embodiment, self-healing of SeDAX hosts provides resilient service against system failures or cyber-attacks. Yet, in other embodiments reliability is attained through self-configurability in the face of system failures.

Each SeDAX node has data aggregator/multicaster or storage that constitutes the data-plane components of the SeDAX platform. These components can be generally called rendezvous points 130.

In one embodiment, a topic-group manager (a control-plane component of the SeDAX platform) creates and manages one rendezvous point per topic-group which represents one instance of a message router or storage. For a particular streaming topic group, its corresponding rendezvous point 130 aggregates data from the publishers of the streaming topic and immediately multicasts the data to the subscribers of the streaming topic. For resilient streaming, information regarding the subscribers of the streaming topic is stored in 130 and replicated to neighboring node 605.

In a query topic-group embodiment, the rendezvous point 130 for that particular query topic-group stores data from the publishers of the particular query topic-group and responds to queries from the subscribers of the particular query topic-group. For improved data availability, the data is replicated to a neighboring node 605. Generally, for any topic-group, the rendezvous point drops data or queries from any unauthorized entities trying to access topic-group.

In data dissemination embodiment, when an RP 130 node collapses, the node closest node to point 605 autonomously becomes RP node for the topics.

In data storage embodiment, nodes incident on the triangle, i.e., node 610 and node 615 enclosing rendezvous point 605 are replicas for RP 130.

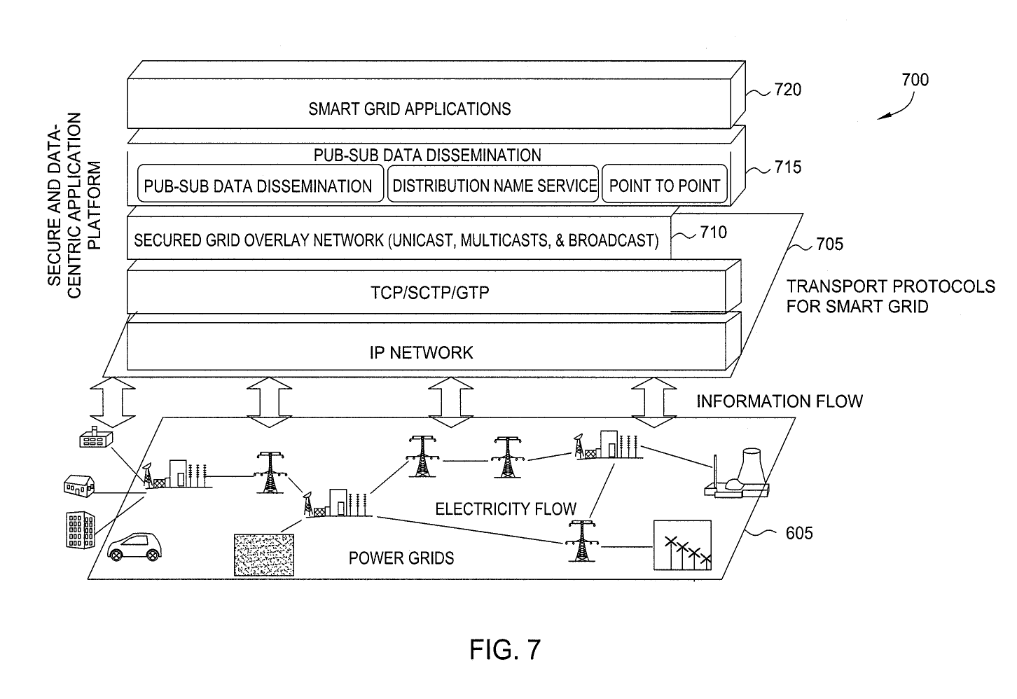

FIG. 7 depicts one embodiment of a Secure Information Service Bus supported by the SeDAX system of FIGS. 1A and 1B. Specifically, FIG. 7 depicts SeDAX for Smart Grid Applications 720. Challenges in the energy industry introduce significant variability in the generation and consumption of power 605. Therefore, in the absence of an advanced communications platform, balancing power supply and demand would become more challenging. These new grid applications could also create fragmentation in the market and complex inter-dependencies on different parts of the grid thus causing serious concerns about the viability of a centralized control. In various embodiments, using the SeDAX platform, Smart Grid supports distributed data sharing and distributed control across wide area networks and across multiple administrative organizations. Further, the SeDAX arrangement addresses the concerns about scalability, availability and security of the grid. The SeDAX infrastructure is well suited for applications such as automated metering, building energy management systems, electric vehicles, distributed solar panels, residential energy storage, advanced demand response programs and the like. An artisan of ordinary skill in the art will appreciate that the SeDAX infrastructure is not limited to these applications.

The SeDAX arrangement is adapted to satisfy the requirements of Smart Grid communications while achieving such objectives as scalability, availability and security. The use of a datacentric platform enables secure data sharing and supports both transaction and query-based communications. Thus, the platform provides an N-way communication infrastructure that spans across multiple grid applications and organizational domains.

In one embodiment, SeDAX provides two kinds of data-centric communication methods; namely, (1) streaming-based data dissemination; and (2) query-based data retrieval. Both of these communication methods are securely overlayed on top of Transmission Control Protocol/Internet Protocol (TCP/IP). Within this overlay, SeDAX uses a scalable and localized data forwarding method, which performs data routing with minimal routing overhead. This feature is based on the properties of the overlay network, which is built on a Delaunay Triangular (DT) graph. DT graph structure also provides another key SeDAX's feature; namely, self-configurable group communication. SeDAX's security framework covers both information and protocol level security.

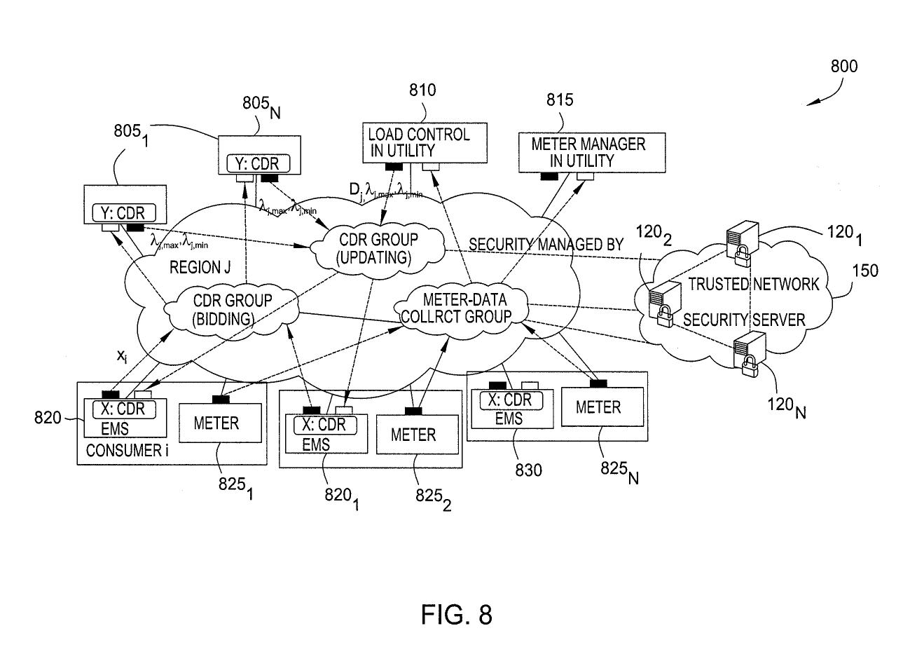

FIG. 8 depicts one embodiment of a Cloud-based Demand Response system supported by the SeDAX system of FIGS. 1A and 1B.

Demand Response (DR) is a Smart Grid application that can be deployed on the SeDAX platform. In one embodiment, SeDAX supports a cloud service provided on the consumer side referred to as cloud-based demand response (CDR). Initially, customers 805-825 who want to participate in the demand response application 720 are authenticated by the secure control server 120. A meter-data collection group 825 is responsible for collecting power consumption data. Based on these measurements the current (power) demand is calculated. In this embodiment, meter-data collection group 825 is equipped with a publisher socket and as such can only participate in a “data-collection” group as a publisher. However, updating function 805, load control 810, meter manager 815, bidding function 820 and EMS 830 are all equipped with publisher/subscriber sockets and can participate in a group as a publisher or subscriber. In other embodiments, other configurations are implemented.

In one embodiment, when the demand is projected to exceed power supply capacity, the demand response application is automatically invoked. This application provides an incentive price for power reduction and this information is multicast throughout a topic-group, called the updating group 805. The participating customers 820 respond with their power reduction bid through the bidding group. Price updating and bidding processes are done iteratively until the optimal equilibrium is found. From the utility's perspective, CDR appears as a black box information system that takes an input (power deficit) from the utility and gives an output (the optimal incentive price and the power reduction on a per customer basis). All computations are done within the SeDAX network, and the utility can deploy demand response as a cloud service.

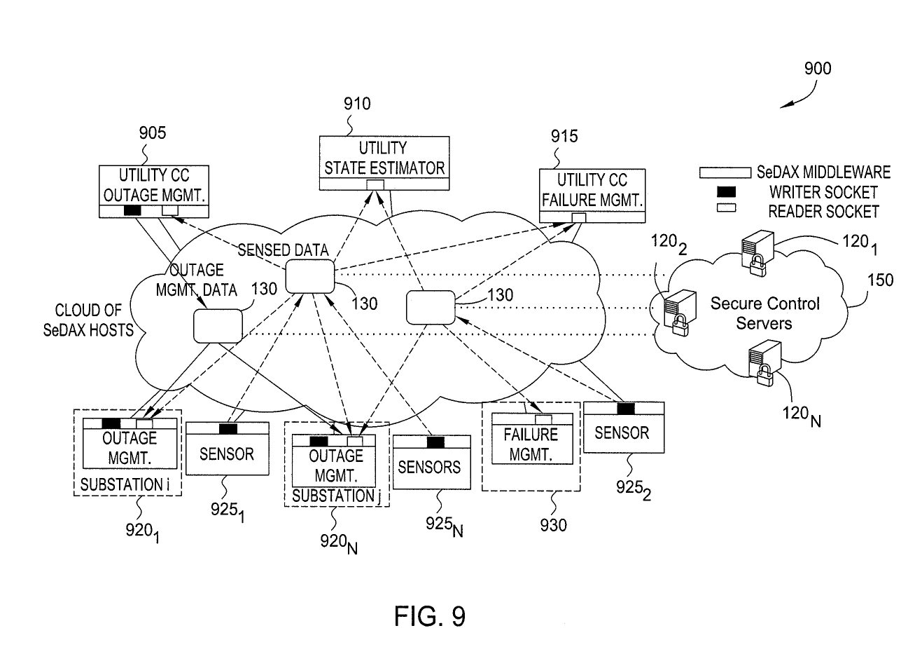

FIG. 9 depicts one Implementation of Decentralized DB over SeDAX supported by the system of FIGS. 1A and 1B. Specifically, in this embodiment a decentralized Data Base is implemented over SeDAX. Initially, nodes 905-930 are authenticated by the secure control server network 120. Each content node is equipped with the SeDAX middleware. As previously articulated, the SeDAX middleware supports three communication primitives; namely, (1) open {topic, role}; (2) write {data}; and (3) read {data}.

In one embodiment, Utility CC Outage Mgmt. 905 and Outage Mgmt. 920 are equipped with both a writer socket and a reader socket; Utility State Estimator 910, Utility Failure Mgmt. 915 and Failure Mgmt. 930 are equipped with a reader socket; Sensors 925 are equipped with a writer socket.

Consequently, using write ( ), nodes 905, 920 and 925 can propagate data toward a SeDAX node in the cloud of SeDAX hosts via the SeDAX middleware which encrypts the data and pushes the encrypted data toward the SeDAX network. Using read( ), nodes 905, 920 and 930 can read data from a SeDAX node via the SeDAX middleware, which receives data from the SeDAX network. In other embodiments, other configurations are implemented.

In various embodiments, for streaming data access, whenever data from a SeDAX network arrives at the node equipped with a reader socket, the read( ) primitive is called to notify its associated application of the arrival of new data. For query-based data retrieval, the centralized DB application calls the read( ) primitive to request the subscriber object to pull data from a SeDAX network. Then, the application waits for a while until the subscriber object obtains the requested data.

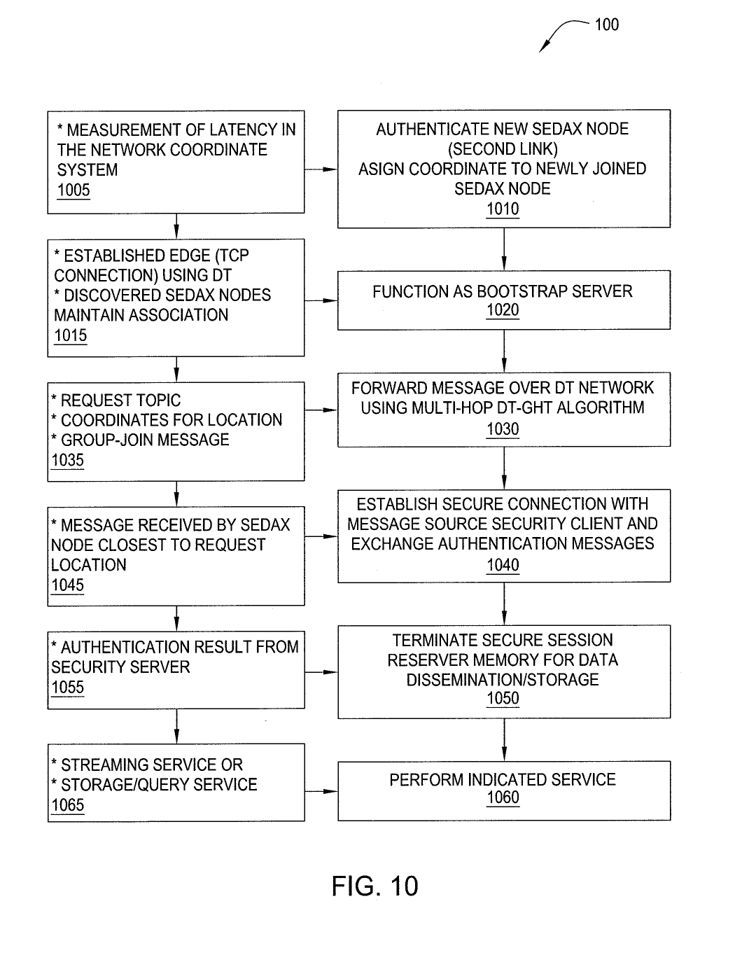

FIG. 10 depicts a flow diagram of a method according to one embodiment. Specifically, FIG. 10 depicts a method suitable for use at a SeDAX node or other entity operative to enable one or more content publishers and/or subscribers to send or receive data without directory service to thereby provide address invisibility of the content publishers and/or subscribers.

At step 1010, a newly booted SeDAX node is authenticated by a security server via the bootstrap server. A network coordinate system is required to embed network latency information. When a SeDAX node joins a SeDAX network, its coordinates are assigned by a security server. This assignment is made based on the measurement of latency to existing nodes in the coordinate system.

At step 1020, once authenticated, the SeDAX node can establish edges (TCP connections) with neighboring SeDAX nodes using a DT construction process.

At step 1030, when a topic specified by an application is passed to either a publisher object or a subscriber object, the topic is input to a geographic hash function which outputs coordinates for the location on a given Euclidean space. A group-join message destined to the determined location is then sent to a SeDAX node associated with the determined location at system initialization time. The SeDAX node forwards the message over a DT-based SeDAX network using the multi-hop forwarding algorithm, DT-GHF.

At step 1040, a topic-group manager in the SeDAX node receives the message and then establishes a secure session with the message source's security client. The security client exchanges authentication messages with a security server. The communications with the security server occurs over a secure session.

At step 1050, after the topic-group manager in the SeDAX node is notified of successful authentication from the security server, the secure session to the security client is terminated and the topic-group manager reserves memory resources for either streaming-based or query-based data dissemination/storage.

At step 1060, the indicated service is performed as described above.

It will be appreciated that functions depicted and described herein may be implemented in software and/or hardware, e.g., using a general purpose computer, one or more application specific integrated circuits (ASIC), and/or any other hardware equivalents. In one embodiment, SeDAX host interface engine 134 can be loaded into memory 133 and executed by processor 132 to implement functions as discussed herein. Thus, SeDAX host interface engine 114, 124, 134, 144 and 164 (including associated data structures) can be stored on a computer readable storage medium, e.g., RAM memory, magnetic or optical drive or diskette, and the like.

It will be appreciated that computer nodes depicted in FIG. 1B provide a general architecture and functionality suitable for implementing functional elements described herein and/or portions of functional elements described herein. For example, computer node 130 provides a general architecture and functionality suitable for implementing one or more of SeDAX self-healing/self-configuration host server arrangement, trusted nodes configured for performing validation and/or authentication functions for use in generating control signals as discussed herein, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, and/or stored within a memory within a computing device operating according to the instructions.

What is claimed is:

1. A method for distributing content, comprising:
receiving a request to join a topic group, said request including characteristics associated with a topic of interest, requester identifier and requester geographic location;
transmitting toward the requester an identifier of a topic group associated with the topic of interest;
receiving indication of requester authentication, said indication being adapted to populate respective topic database;
receiving message content including the topic group identifier associated with of the topic interest; and
caching the topic of interest message at a host.

2. The method of claim 1, wherein geographic location is determined for a topic group using a distributed hash function.

3. The method of claim 1, wherein for a geographic location associated with a particular topic group a host closest to the location becomes a primary rendezvous point (RP) for the topic group.

4. The method of claim 3, wherein for a geographic location associated with a particular topic group a host that is second closest to the location becomes a secondary RP node for the topic group upon unavailability of the primary RP.

5. The method of claim 1, wherein nodes incident on a triangle enclosing the primary RP are replicas of said primary RP.

6. The method of claim 1, wherein the request to join further includes the identifier of the requester and geographic location.

7. The method of claim 1, wherein the response to join further includes the identifier of the content publisher.

8. The method of claim 1, further comprising waiting for authentication of said requester.

9. The method of claim 8, wherein the requester obtains authentication from a trusted server.

10. The method of claim 1, wherein the authentication response further includes a credential and identifier of the content publisher.

11. The method of claim 1, further comprising transmitting cached topic of interest messages to the requester.

12. The method of claim 4, wherein the primary RP sends toward the secondary node updated data.

13. A method for providing content to a subscriber over a network, comprising:
receiving a request to join a topic group including characteristics associated with a topic of interest, requester identifier and geographic location;
transmitting toward the requester an identifier of a topic group associated with the topic of interest;
receiving indication of requester authentication, said indication being adapted to populate respective topic database;
providing the topic of interest message content to the subscriber over a secure data-centric application extension platform (SeDAX).

14. The method of claim 13, wherein the request to join further includes the identifier of the subscriber and geographic location.

15. The method of claim 14, further comprising authenticating said subscriber.

16. The method of claim 15, wherein subscriber authentication is provided via a trusted server.

17. The method of claim 13, wherein a geographic location is determined for a topic group using a distributed hash function.

18. The method of claim 13, wherein for a geographic location associated with a particular topic group a host closest to the location becomes a primary rendezvous point (RP) for the topic group.

19. An apparatus for hosting a secure data-centric application extension platform (SeDAX) over a network, comprising:
a processor adapted to perform a plurality of SeDAX functions using a SeDAX middleware suite and a SeDAX host suite;
the SeDAX middleware suite enabling communications with one or more end users such as publishers or subscribers;
the SeDAX host suite enabling communications with other SeDAX middleware suites and other SeDAX host suites to thereby implement a SeDAX network including one or more trusted servers;
wherein a SeDAX host proximate a determined location becomes a rendezvous point between publishers and subscribers thereby providing address invisibility.

20. A computer program product for scalably and securely requesting content over a network using a secure data-centric application extension platform (SeDAX) adapted to locate a content of provider or publisher without directory service, the computer program product being embodied in a non-transitory computer readable medium storing thereon computer instructions for:
implementing distributed storage capability over a SeDAX network;
providing fine-grained topic or role based access control; and
implementing self-healing and self-configuration capability of the SeDAX network;
wherein the SeDAX network comprises one or more nodes in communication, each of said one or more nodes a SeDAX host suite.
